(19) United States
(12) Patent Application Publication
(10) Pub. No.: US 2017/0143999 A1
(43) Pub. Date: May 25, 2017

(54) WRIST-WORN GLASS BREAKING TOOL

(71) Applicant: David A. Pomeroy, Pahrump, NV (US)

(72) Inventor: David A. Pomeroy, Pahrump, NV (US)

(21) Appl. No.: 15/359,704

(22) Filed: Nov. 23, 2016

Related U.S. Application Data
(60) Provisional application No. 62/259,902, filed on Nov. 25, 2015.

(51) Int. Cl. A62B 3/00; A45F 5/00

(52) U.S. Cl. CPC A62B 3/005; A45F 5/00

(57) ABSTRACT

A wrist worn emergency window-breaking apparatus that includes a window-breaking punch tool and a wrist strap. A platform base secured to the wrist strap supports a striking tip of pointed form.

### RELATED APPLICATIONS

This application claims priority to U.S. Provisional Application No. 62/259,902 filed Nov. 25, 2015. The entire contents of the above application are hereby incorporated by reference as though fully set forth herein.

### BACKGROUND

This invention relates generally to the field of police, military and law enforcement equipment. More particularly, the invention relates to a compact, wrist-worn window-breaking tool that allows the tool to be carried safely on the person and yet be immediately accessible for emergency use.

In police and other public safety lines of work, sometimes windows need to be broken immediately in order to gain access to a building or vehicle. For example, an unconscious or injured person or infant may be locked in an automobile that has caught on fire or is about to be submerged in water. In such circumstances, the immediate breaking of a window to either unlock the door or provide a means of egress from the vehicle is literally a matter of life or death for the person trapped in the vehicle.

There are several window-breaking devices known in the prior art, such as tactical police batons or small, hand-held window-breaking punches or hammers. The prior art window-breaking techniques using baton are often ineffective as the tempered glass found on the side windows of contemporary automobiles is extremely difficult to break with a police baton, even when a very hard blow is delivered. While small hand-held window breaking punches or hammers offer an advantage over police batons, the punch tip is often exposed and cannot be safely carried by the user due to the risk of puncture wounds. For example, if the hammer or punch is kept in a shirt pocket or on a waist belt and the user falls, the tip of the punch or hammer can cause a puncture wound to the chest or abdomen. As a result, many users carry these devices in their duty vehicle, which means the tool is not readily available for use in an emergency situation where an officer may only have seconds to extract a passenger from a vehicle.

The present invention provides an emergency window-breaking punch worn on the wrist that overcomes the problems of the prior art. The wrist worn aspect protects the user from possible puncture from the window-breaking punch, allowing the punch to be carried on the person without risk of injury. Further, the wrist worn strap allows the window-breaking punch to be immediately.

### BRIEF SUMMARY OF THE INVENTION

The present invention is a wrist worn emergency window-breaking apparatus that includes a window-breaking punch tool and a wrist strap. A platform base secured to the wrist strap supports a striking tip of pointed form. In the preferred embodiment, the striking tip is constructed from carbide but may also be constructed from stainless steel or other materials known to shatter glass when used to strike glass. The platform base may be constructed out of a variety of materials, including but not limited to stainless steel, molded plastic, rubber, leather, and nylon or other synthetic textiles. On the opposite sides of the internal surface of the platform base are two sidewalls defining openings or slots permitting the passage of the strap through the ends or sides of the platform base. The strap may be secured around the user's wrist using a variety of wrist band securing devices known in the prior art, including but not limited to a buckle, snap, or Velcro attachment. The strap may be constructed out of a variety of materials such as rubber, metal links, molded plastic, leather, and nylon or other synthetic textiles.

### BRIEF DESCRIPTION OF THE DRAWINGS

FIG. 1. Top view of the wrist-worn, emergency glass-breaking device of the present invention.

FIG. 2. Bottom view of the wrist-worn, emergency glass-breaking device of the present invention.

FIG. 3. Side view of the wrist-worn, emergency glass-breaking device of the present invention.

FIG. 4. Top view of the wrist-worn, emergency glass-breaking device of the present invention wrapped around a user's wrist.

FIG. 5. Side view of the wrist-worn, emergency glass-breaking device of the present invention wrapped around a user's wrist.

FIG. 6. Bottom view of the wrist-worn, emergency glass-breaking device of the present invention wrapped around a user's wrist.

FIG. 7. Top view of the platform base of the wrist-worn, emergency glass-breaking device of the present invention wrapped around a user's wrist.

FIG. 8. Bottom view of the platform base of the wrist-worn, emergency glass-breaking device of the present invention wrapped around a user's wrist.

FIG. 9. Side view of the platform base of the wrist-worn, emergency glass-breaking device of the present invention wrapped around a user's wrist.

FIG. 10. Perspective view of the wrist-worn, emergency glass-breaking device of the present invention with a hook and loop securing means.

### DETAILED DESCRIPTION

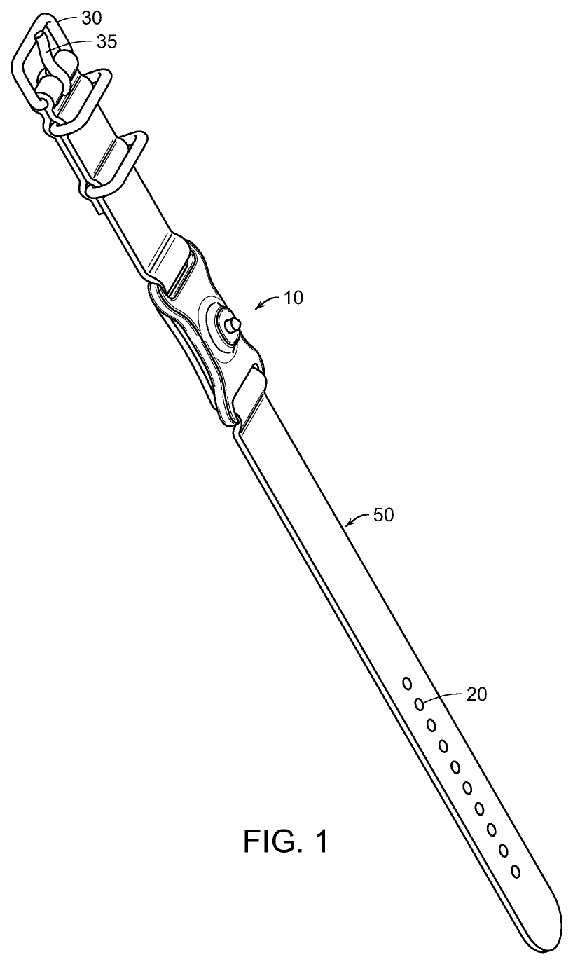

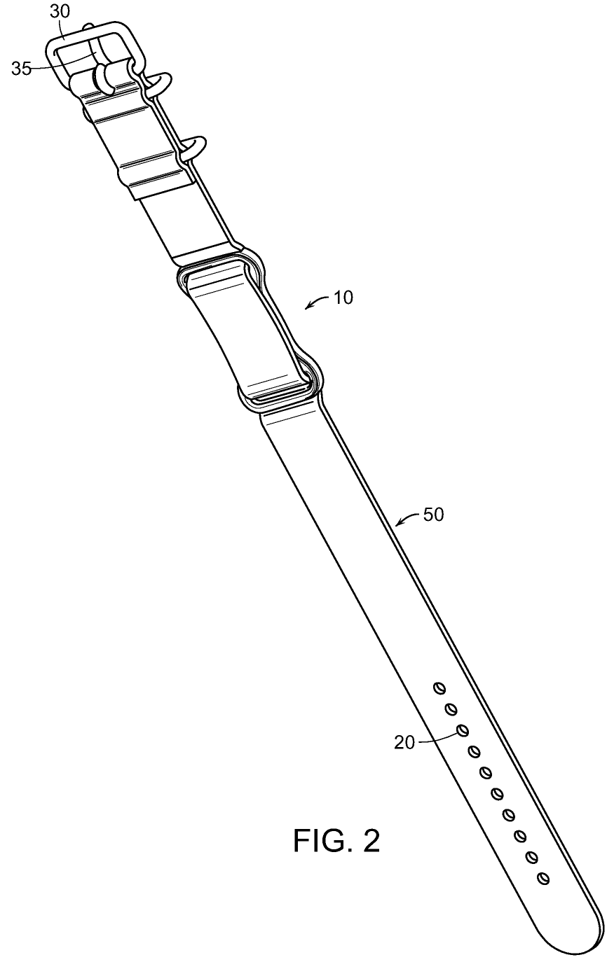

Turning to FIGS. 1 and 2, the wrist-worn emergency glass breaking device of the present invention is shown from a top and bottom views. A platform 10 supports a window breaking punch protruding from the platform 10, the platform 10 being attached to a strap 50 with a first end and an intermediate portion and a second end, wherein the strap may be secured around a user's wrist using a wrist strap attachment means for releasably securing the wrist strap around a user's wrist. In the preferred embodiment, the platform 10 is secured to the intermediate portion of said wrist strap.

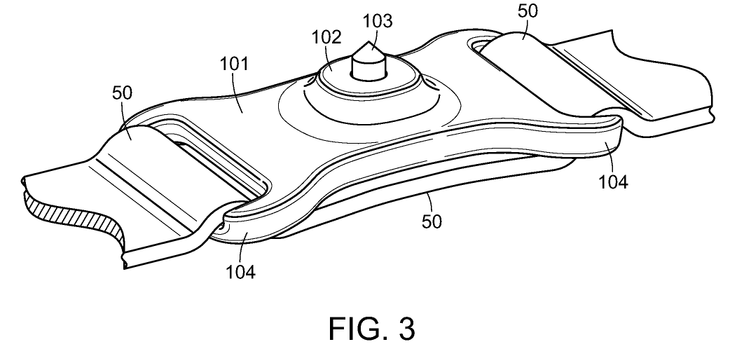

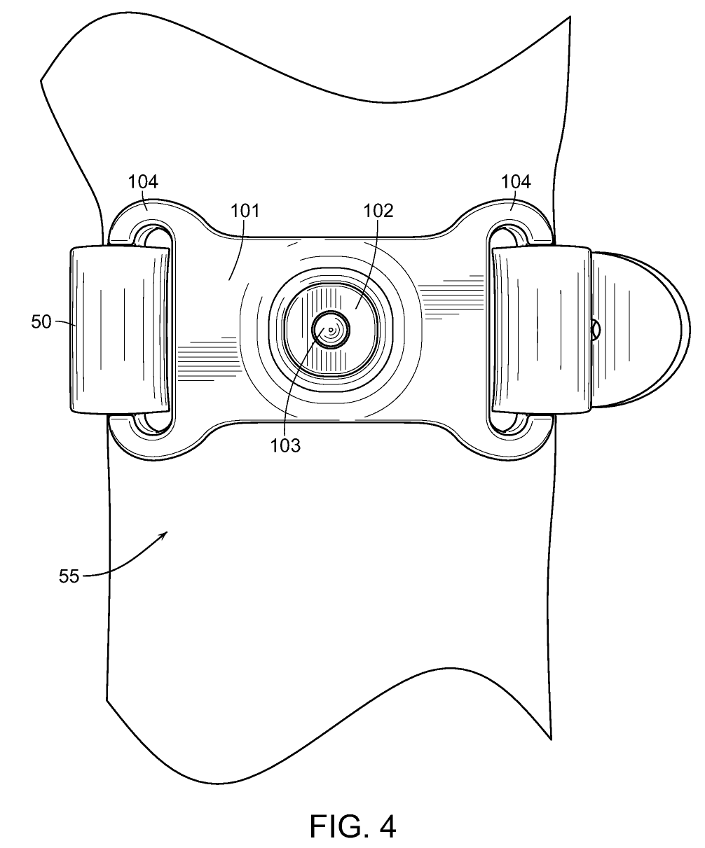

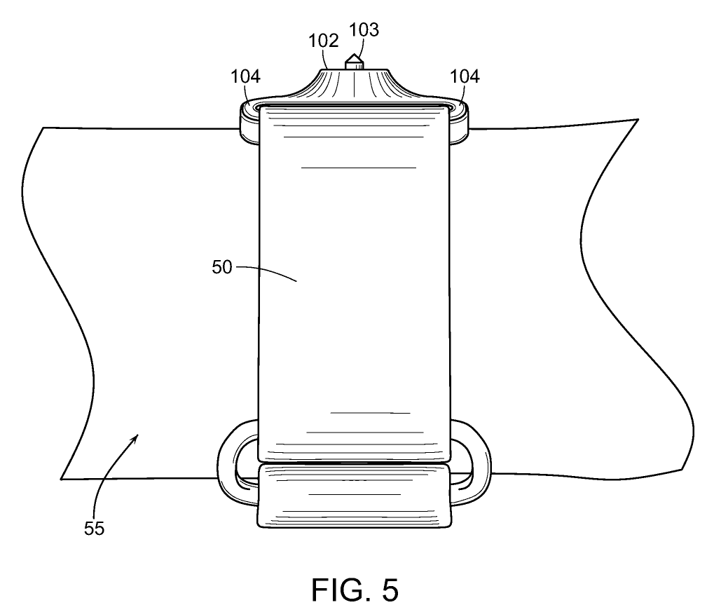

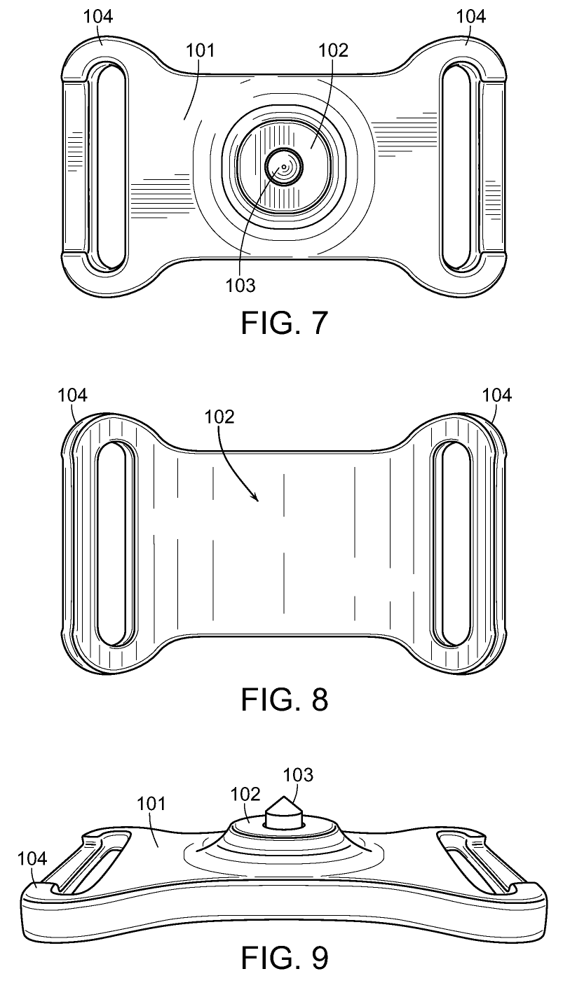

Turning to FIGS. 3-4 and 7-9, the platform 10 is shown in greater detail. In the preferred embodiment, an elevated ridge 102 extends outward from the platform base front 101 (platform base back 102 in FIG. 8). The elevated ridge 102 supports an embedded striking tip 103. In the preferred embodiment, the striking tip 103 is constructed from tungsten carbide but may also be constructed from stainless steel or other materials known to shatter glass when used to strike glass. The platform base 101 and elevated ridge 102 may be constructed out of a variety of materials, including but not limited to stainless steel, molded plastic, rubber, leather, and nylon or other synthetic textiles. The platform base 101 and elevated ridge 102 may be formed in a single continuous rigid component or may be formed in separate components and secured together in the configuration shown in the Figures.

There are various configurations that would allow the platform base 10 to be attached to the strap 50. For example, as shown in the Figures, on the opposite sides of the internal surface of the platform base 101 are two sidewalls 104 defining openings (or slots) permitting the passage of the strap 50 through the ends or sides of the platform base 101. The openings may be completely surrounded by the sidewalls or there may be a notch in the sidewall to allow insertion of the strap rather than sliding the strap through the sidewalls. The sidewalls may be located on the opposing ends such as shown in the Figures. However, it is also contemplated that the sidewalls be located on the opposing sides such that the strap fits into a notch within the side walls.

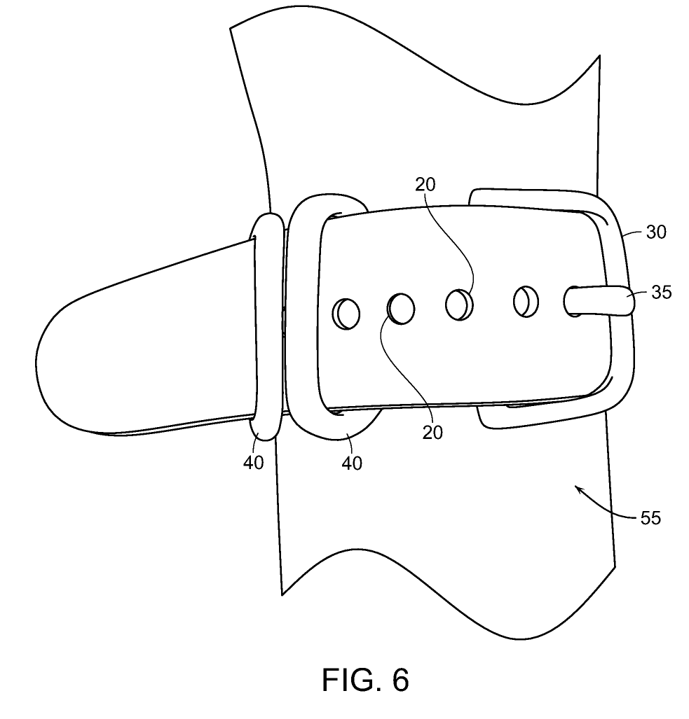

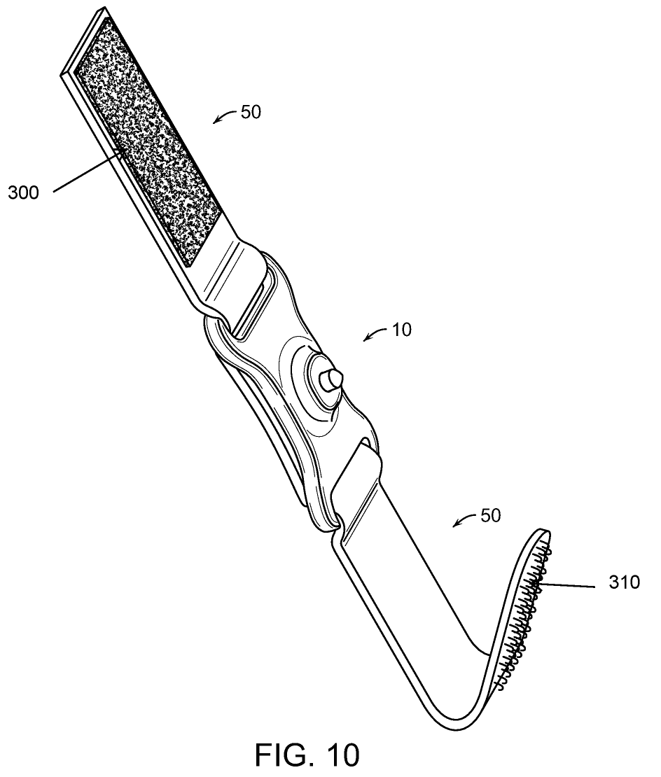

There are various ways to secure the strap to the user's wrist designated as 55 in the Figures, including but not limited to a buckle, snap, or Velcro attachment. For example, as shown in FIG. 6, at one end portion of the strap, a buckle 30, buckle loops 40 and a rigid pin 35 is affixed at the end of the fold of the strap. At the other end portion of the strap, lodging notches 20 extend through the strap. When the strap is extended through the buckle 30, the outwardly extending end of the pin 35 engages one of the lodging notches 20 and the strap 50 is folded under the buckle loops 40 to engage and secure the buckle. Another example is FIG. 10 wherein a hook portion 300 lines the first end of the wrist strap and a loop portion 310 lines the opposite end of the strap. The two ends connect to secure the strap around a user's wrist.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the system (and components of the individual operating components of the system) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A tool for breaking a window glass, said tool comprising:
a. a wrist strap having a first end and an intermediate portion and a second end,
b. a wrist strap attachment means for releasably securing the wrist strap around a user's wrist,
c. a platform base with a front and back portion secured to said intermediate portion of said wrist strap; and
d. a window-breaking punch attached to the platform base.

2. The tool of claim 1 wherein said window-breaking punch comprises
a. an elevated ridge extending outwardly from the front portion of the platform base; and
b. a striking tip embedded in the elevated ridge.

3. The tool of claim 2 wherein the platform base and the elevated ridge are formed in a single continuous rigid component.

4. The tool of claim 2 wherein the platform base and the elevated ridge are formed in separate rigid components.

5. The tool of claim 2 wherein the striking tip is constructed from a material capable of shattering glass.

6. The tool of claim 2 wherein the striking tip is constructed tungsten carbide.

7. The tool of claim 2 wherein the striking tip is constructed from stainless steel.

8. The tool of claim 1 wherein the platform base is constructed out of materials selected from the group comprising stainless steel, molded plastic, rubber, leather, nylon, synthetic textiles or combinations thereof.

9. The tool of claim 2 wherein the elevated ridge is constructed out of materials selected from the group comprising stainless steel, molded plastic, rubber, leather, nylon, synthetic textiles or combinations thereof.

10. The tool of claim 1 wherein the platform base further comprises sidewalls on opposite ends of the platform base with apertures through the sidewalls, thereby permitting the passage of the wrist strap through the ends of the platform base.

11. The tool of claim 1 wherein the platform base further comprises sidewalls on opposite sides of the platform base with apertures through the sidewalls, thereby permitting the passage of the wrist strap through the sides of the platform base.

12. The tool of claim 1 further comprising hook material at the first end of the wrist strap and loop material at the second end of the wrist strap.

13. The tool of claim 1 further comprising a pin buckle at the first end of the wrist strap and a series of lodging notches extending through the second end of the wrist strap.

14. A tool for breaking a window glass, said tool comprising:
a. a wrist strap having a first end and an intermediate portion and a second end,
b. a wrist strap attachment means for releasably securing the wrist strap around a user's wrist,
c. a platform base with a front and back portion secured to said intermediate portion of said wrist strap;
d. sidewalls on opposite ends of the platform base with apertures through the sidewalls; and
e. a pin buckle at the first end of the wrist strap and a series of lodging notches extending through the second end of the wrist strap

15. The tool of claim 14 wherein said window-breaking punch comprises
a. an elevated ridge extending outwardly from the front portion of the platform base; and
b. a striking tip embedded in the elevated ridge.

16. The tool of claim 15 wherein the striking tip is constructed from a material capable of shattering glass.

17. A tool for breaking a window glass, said tool comprising:
a. a wrist strap having a first end and an intermediate portion and a second end,
b. a wrist strap attachment means for releasably securing the wrist strap around a user's wrist,
c. a platform base with a front and back portion secured to said intermediate portion of said wrist strap;
d. sidewalls on opposite ends of the platform base with apertures through the sidewalls;
e. an elevated ridge extending outwardly from the front portion of the platform base; and
f. a striking tip embedded in the elevated ridge.

18. The tool of claim 17 wherein the striking tip is constructed from a material capable of shattering glass.

19. The tool of claim 17 wherein the striking tip is constructed tungsten carbide.

20. The tool of claim 17 wherein the striking tip is constructed from stainless steel.
